(19) United States
(12) Patent Application Publication
(10) Pub. No.: US 2016/0034083 A1
(43) Pub. Date: Feb. 4, 2016

(54) TOUCH SENSING DEVICE

(71) Applicant: IBIS INNOTECH INC., Taichung City (TW)

(72) Inventors: Wei-Jen LAI, Jhubei City (TW); Chih-Kung HUANG, Hsinchu City (TW)

(21) Appl. No.: 14/581,835

(22) Filed: Dec. 23, 2014

(30) Foreign Application Priority Data
Jul. 29, 2014 (TW) 103213428

(51) Int. Cl. G06F 3/041

(52) U.S. Cl. CPC G06F 3/0412; G06F 2203/04103

(57) ABSTRACT

A touch sensing device includes a light-transmitting substrate, an edge layer and sensing lines. The light-transmitting substrate has an upper surface and a lower surface opposite to the upper surface, and the edge layer is covered on an edge of the upper surface of the light-transmitting substrate. The edge layer has a main body made of insulated material, and conductive wires. The main body has a first surface attached on the upper surface of the light-transmitting substrate, a second surface opposite and parallel to the first surface, and slots recessed downwardly from the second surface. The conductive wires are embedded in the slots, respectively. The sensing lines are disposed on the upper surface of the light-transmitting substrate and electrically connected with the conductive wires, respectively. Therefore, the touch sensing device can have simple and quick manufacturing process, high yield rate and low cost.

### BACKGROUND

1. Technical Field

The present disclosure relates to a touch control panel device and more particularly, to a touch sensing device having a simple and quick manufacturing process, a high yield rate and a low cost.

2. Description of Related Art

In a traditional touch sensing device, a black matrix for blocking light is formed on a surface of a transparent substrate by screen printing, and a patterned transparent ITO conductive layer is then formed as a sensing circuit on the area surrounded by the black matrix on the surface of the transparent substrate by sputtering. Because a thickness of the black matrix is larger than that of the transparent conductive layer, the gap between the black matrix and the substrate should be filled with silicon dioxide by sputtering first, so that the transparent conductive layer can be continuously covered on the black matrix and the area surrounded by the black matrix. Next, a silver adhesive layer is coated on the black matrix, and preset patterned circuits are formed by performing laser cutting on the silver adhesive layer, such that the electric variations of the sensing lines can be transmitted to a microprocessor via the silver adhesive circuits.

The aforesaid manufacturing process of the touch sensing device is very complicated, and the sputtering coating process is very expensive and requires large vacuum equipment. In addition, the black matrix below the silver adhesive layer tends to be damaged when the silver adhesive layer is cut by laser, and the silver adhesive chips produced during the cutting tend to attach on and then contaminate the transparent conductive layer, deteriorating the yield rate and increasing the manufacturing cost.

### SUMMARY

An exemplary embodiment of the present disclosure provides a touch sensing device which has advantages of simple and quick manufacturing process, and high yield rate and low cost.

According to one exemplary embodiment of the present disclosure, the touch sensing device of the present disclosure includes a light-transmitting substrate, an edge layer and a plurality of sensing lines. The light-transmitting substrate is made of glass or polymer material and has an upper surface and a lower surface opposite to the upper surface. The edge layer is covered on at least one edge of the upper surface of the light-transmitting substrate and has a main body made of insulated material, and a plurality of conductive wires. The main body has a first surface attached on the upper surface of the light-transmitting substrate, a second surface opposite and parallel to the first surface, and a plurality of slots recessed downwardly from the second surface. The plurality of conductive wires are embedded in the plurality of slots, respectively. The plurality of sensing lines are disposed on the upper surface of the light-transmitting substrate and electrically connected with the plurality of conductive wires, respectively.

By means of ink-jetting or screen printing, the edge layer and the sensing lines of the touch sending device of the present disclosure can be formed without the problem of silver adhesive contamination, such that the touch sensing device has advantages of simple and quick manufacturing process, high yield rate and low cost.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a top view of a first preferred embodiment of the present disclosure;

FIG. 2 is a cross-sectional view taken along line 2-2 of FIG. 1;

FIG. 3 is a partial top view of the first preferred embodiment of the present disclosure;

FIG. 4 is a cross-sectional view taken along line 4-4 of FIG. 3; and

FIG. 5 is a cross-sectional view taken along line 5-5 of FIG. 3.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

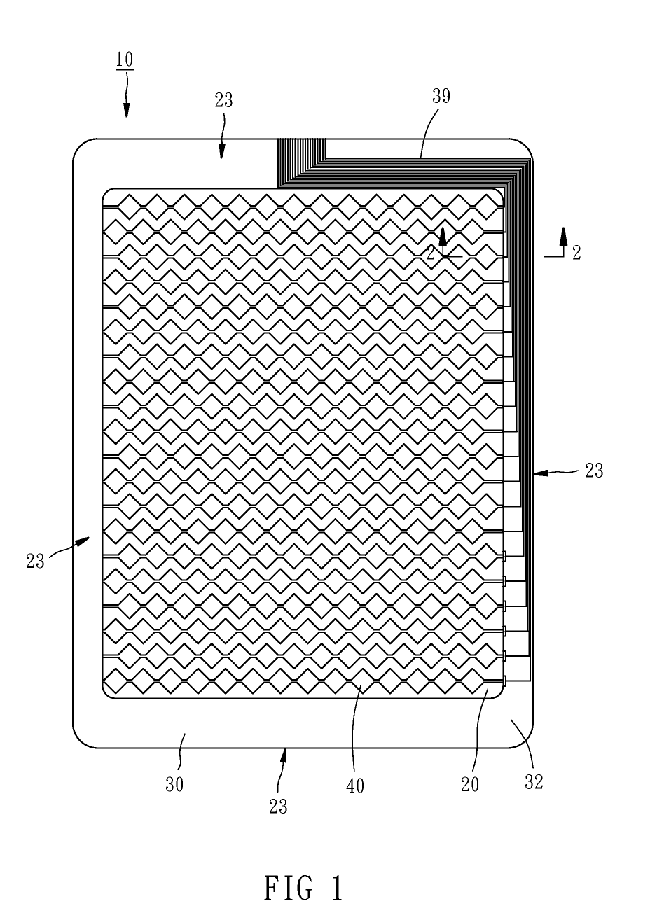

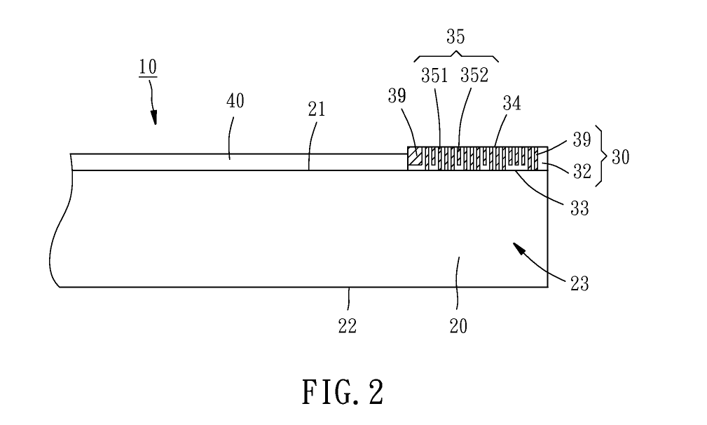

Please refer to FIG. 1 and FIG. 2, a touch sensing device 10 provided by a first preferred embodiment of the present disclosure includes a light-transmitting substrate 20, an edge layer 30 and a plurality of sensing lines 40.

The light-transmitting substrate 20 may be made of glass or polymer material. The higher the transmittance of a material has, the more preferable the material is used to make the light-transmitting substrate. For polymer material, polyethylene terephthalate (PET), polycarbonate (PC), Polyethylene (PE), polyvinyl chloride (PVC), polypropylene (PP), polystyrene (PS), or polymethylmethacrylate (PMMA) may be used. The light-transmitting substrate 20 has an upper surface 21 and a lower surface 22 opposite to the upper surface 21.

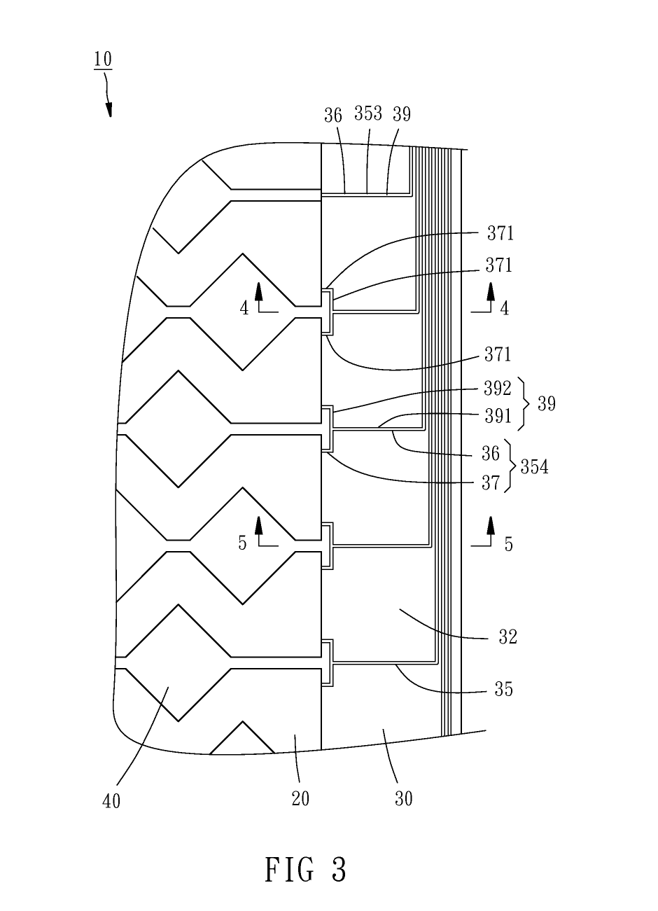

The edge layer 30 is covered on the four edges 23 or the peripheral of the upper surface 21 of the light-transmitting substrate 20 by ink-jetting or screen printing, with a thickness of about 5 μm. The edge layer 30 has a main body 32 made of insulated material, and a plurality of conductive wires 39. The material of the main body 32 may be polymer material such as epoxy resin, or polymethylmethacrylate (PMMA), etc., and such material may be added with a light blocking material such as toner, to enable the edge layer 30 to having light blocking property. The main body 32 has a first surface 33 at the bottom thereof and attached on the upper surface 21 of the light-transmitting substrate 20, a second surface 34 at the top thereof and opposite and parallel to the first surface 33, and a plurality of slots 35 recessed downwardly from the second surface 34. The slots 35 can be formed by etching the main body 32 by laser or other proper method, and the minimal line pitch is about or less than 10 μm. Some slots 351 penetrate through the main body 32, but other slots 352 do not. The slots 35 are arranged in parallel substantially along the two edges 23 of the light-transmitting substrate 20, as shown in FIG. 3. Some slots 353 each have a narrow slot portion 36 only, and the other slots 354 each have the narrow slot portion 36 and a wide slot portion 37. The wide slot portion 37 is located at inner side of the edge layer 30 and communicated with the narrow slot portion 36. As implied in the name, the width of the wide slot portion 37 is larger than that of the narrow slot portion 36. It should be illustrated that both of the narrow slot portion 36 and the wide slot portion 37 of one slot 35 may or may not penetrate through the main body 32; alternately, one of the narrow slot portion 36 and the wide slot portion 37 may penetrate through the main body 32, and the other does not penetrate through the main body 32.

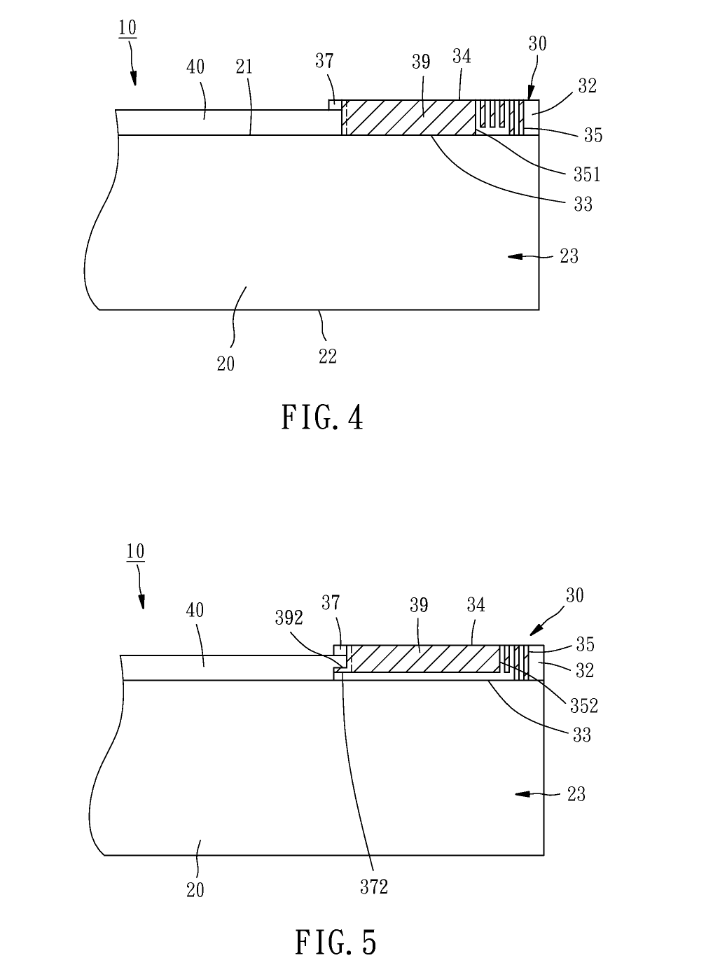

In this disclosure, the definition of above and below is determined according to the line-of-sight direction of the FIG. 2, i.e. the upper part of the FIG. 2 is defined as the above, and the lower part of the FIG. 2 is defined as the below. The conductive wires 39 are embedded in the slots 35, and the material of the conductive wires 39 may be copper, copper alloy, Ag, Ag alloy or other conductive material. The conductive wires 39 may be configured to fill the slots 35 fully, or fill the slots 35 partially. The conductive wires 39 in the slots 351 penetrating through the main body 32 may be in contact with the upper surface 21 of the light-transmitting substrate 20. In this embodiment, the conductive wires 39 may be formed at side walls and bottom walls (if existing) of the slots 35 by chemical deposition or electroplating. Because widths of the narrow slot portions 36 of the slots 35 are relatively smaller, the conductive wires 39 usually fill the narrow slot portions 36 fully; in contrast, widths of the wide slot portions 37 of the slots 354 are relatively larger, the conductive wires 39 are usually just formed on the three side walls 371 of the wide slot portion 37 and may not fill the wide slot portions 37 fully if these wide slot portions 37 penetrate through the main body 32, as shown in FIG. 3 and FIG. 4. In view of this structure, each of the conductive wires 39 has a narrow wire portion 391 received in the narrow slot portion 36, and a connecting portion 392 covered on the peripheral wall of the wide slot portion 37. In this embodiment, the connecting portion 392 is covered on the three side walls 371 of the wide slot portion 37 and contacts with the upper surface 21 of the light-transmitting substrate 20. However, in other embodiment, the wide slot portion 37 may have other shape and its peripheral wall is not necessarily formed by three side walls.

If the wide slot portion 37 does not penetrate through the main body 32, the conductive wire 39 will be formed on three side walls 371 and a bottom wall 372 of the wide slot portion 37, and similarly may not fill the wide slot portion 37 fully, as shown FIG. 3 and FIG. 5. In this structural design, the connecting portion 392 of the conductive wire 39 is covered on the side walls 371 and the bottom wall 372, which form the peripheral wall of the wide slot portion 37. However, in other embodiment, the peripheral wall of the wide slot portion 37 may have other shape such as semi-tapered shape without the side walls or the bottom wall.

As shown in FIG. 3, for the slot 353 not having the wide slot portion 37, the conductive wire 39 is not divided into the narrow wire portion and the connecting portion.

In this embodiment, the edge layer 30 is disposed around the light-transmitting substrate 20 to form a boundary frame; however, the practical manufacture is not limited to such structural design, and the edge layer 30 may be just covered one or more edges 23 of the light-transmitting substrate 20.

The sensing lines 40 are disposed on the upper surface 21 of the light-transmitting substrate 20 by ink-jetting or screen printing, and the sensing lines 40 are located at the area surrounded by the edge layer 30. The sensing lines 40 each have preset patterns, such as lozenge, circle or irregular shape, respectively and are arranged in parallel substantially to each other in intervals. The sensing lines 40 are made of light transmittable material such as ITO, or conductive polymer material such as PEDOT. The sensing lines 40 are electrically connected with the conductive wires 39, respectively. Because the process of manufacturing the sensing lines 40 is performed after the manufacturing process of the edge layer 30, an end of each of the sensing lines 40 is extended horizontally into the wide slot portion 37 of the respective slot 35 and connected with the connecting portion 392 of the respective conductive wire 39, as shown in FIG. 3 through FIG. 5, and covered vertically on the connecting portion 392 of the respective conductive wire 39 located on the bottom wall 372 of the respective wide slot portion 37, as shown in FIG. 5. For the slot 353 not having the wide slot portion 37, an end of the sensing line 40 is directly connected with an end of the respective conductive wire 39, as shown in FIG. 2. Therefore, when the user operates the touch control, electrical variations of capacitances on the sensing lines 40 can be transmitted via the conductive wires 39.

In this embodiment, the sensing lines 40 are extended along the left-right direction of the FIG. 1, and the conductive wires 39 are distributed at the right side and the top side of the edge layer 30. Without departing from the aspect of the present disclosure, those skilled in the art can form sensing lines extending along an up-down direction of FIG. 1 on other light-transmitting substrate and form conductive wires at the lower side, left side and top side of the edge layer, and then overlay the other substrate with the substrate 20 together to form an integrated touch control sensing device. Thereafter, the surface of the integrated touch control sensing device is covered with a protection plate having a black matrix corresponding in location to the edge layer. In cooperation with a microprocessor connected with the conductive wires of the integrated touch control sensing device, a touch control module product is thus obtained. If all of the slots within the edge layers of the two light-transmitting substrates do not penetrate through the main bodies which contain light blocking material such as toner, the main bodies can further have the function of black matrix, so that the protection plate can be omitted.

Because the touch sensing device of the present disclosure can be made by steps of ink-jetting, screen printing, laser cutting and chemical deposition, the manufacturing process is simple and quick without expensive sputtering coating equipment and silver adhesive chips which may contaminate the substrate, so that the product yield rate can be efficiently improved and the manufacturing cost can be reduced efficiently. In addition, the edge layer can apply the traditional black matrix material to perform the light blocking effect, so that the structure of the touch control module product can be further simplified and the cost can be reduced, to make the touch sensing device of the present disclosure have excessive market potential.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A touch sensing device, comprising:
a light-transmitting substrate made of glass or polymer material and having an upper surface and a lower surface opposite to the upper surface;
an edge layer covered on at least one edge of the upper surface of the light-transmitting substrate and having a main body made of an insulated material, and a plurality of conductive wires, the main body having a first surface attached on the upper surface of the light-transmitting substrate, a second surface opposite and parallel to the first surface, and a plurality of slots recessed downwardly from the second surface, the plurality of conductive wires being embedded in the plurality of slots, respectively; and
a plurality of sensing lines disposed on the upper surface of the light-transmitting substrate and each electrically connected with one of the conductive wires.

2. The touch sensing device as defined in claim 1, wherein the main body of the edge layer is not penetrated through by the plurality of slots.

3. The touch sensing device as defined in claim 1, wherein the main body of the edge layer is penetrated through by the plurality of slots, such that the conductive wires are attached on the upper surface of the light-transmitting substrate.

4. The touch sensing device as defined in claim 1, wherein each of the plurality of slots has a narrow slot portion and a wide slot portion, and each of the plurality of conductive wires has a narrow wire portion received in the narrow slot portion, and a connecting portion covered on a peripheral wall of the wide slot portion; an end of each of the plurality of sensing lines is received in the wide slot portion of one of the slots and connected with the connecting portion of the conductive wire that is covered on the peripheral wall of the wide slot portion of the one of the slots.

5. The touch sensing device as defined in claim 4, wherein the wide slot portions of the plurality of slots do not penetrate through the main body of the edge layer; the connecting portion of each of the plurality of conductive wires is disposed on a side wall and a bottom wall of the wide slot portion of one of the plurality of slots.

6. The touch sensing device as defined in claim 4, wherein the main body of the edge layer is penetrated through by the wide slot portions of the plurality of slots; the connecting portion of each of the plurality of conductive wires is disposed on a side wall of the wide slot portion of one of the plurality of slots and in contact with the upper surface of the light-transmitting substrate.

7. The touch sensing device as defined in claim 1, wherein the edge layer is disposed at a peripheral of the light-transmitting substrate and surrounds around the plurality of sensing lines.

8. The touch sensing device as defined in claim 1, wherein the main body of the edge layer is made of light blocking material.

9. The touch sensing device as defined in claim 1, wherein the plurality of sensing lines are made of transparent material.
